(19) United States
(12) Patent Application Publication
(10) Pub. No.: US 2001/0051213 A1
(43) Pub. Date: Dec. 13, 2001

(54) PROCESS FOR DEPOSITING OPTICAL LAYERS

(76) Inventors: JOCHEN SCHULZ, VEITSHOCHHEIM (DE); LUTZ BUTTGENBACH, OBER-RAMSTADT (DE); HELMUT DISLICH, BUDENHEIM (DE); FRIEDRICH KONIG, REINHEIM (DE); WALTHER GLAUBITT, VEITSHOCHHEIM (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/134,920

(22) Filed: Aug. 17, 1998

(30) Foreign Application Priority Data
Aug. 16, 1997 (DE) 197 35 493.9
Jun. 25, 1998 (DE) 198 28 231.1

(51) Int. Cl. B05D 5/06

(52) U.S. Cl. 427/162; 427/164; 427/165; 427/168; 427/169

(57) ABSTRACT

A process for depositing optical layers of metal oxides on glass, ceramics or metals, by subjecting the substrate which is to be coated to a purifying pretreatment, purifying the aqueous sol of a metal oxide or a mixture of metal oxides, applying the aqueous sol or sol mixture to the substrate which is to be coated, and heat-treating the coated substrate at temperatures of from 100 to 550° C.

### BACKGROUND OF THE INVENTION

On both environmental and safety grounds it is worth attempting, when preparing optical layers from liquid precursors, to employ systems which avoid flammable and/or toxic solvents. Processes employed to date start from organometallic compounds. The organometallic compounds are hydrolyzed on the substrate which is to be coated and which by raising the temperature are polycondensed into a hard and abrasion-resistant film of a metal oxide. These processes start from alkoxides or acetylacetonates which are hydrolyzed with water. The resulting coating solutions therefore comprise alcohols or other organic solvents. In addition, organic solvents are frequently added in order to improve the flow properties and the viscosity.

EP 0 514 973 describes a sol-gel process for depositing antireflection layers on glass, which layers possess high scratch resistance and a low sensitivity to moisture. Alcoholic solutions of alkoxides of the elements silicon, aluminum or titanium are applied to the substrate together with water and with the addition of small amounts of hydrochloric acid and are brought into contact for 20 minutes with a water vapor atmosphere. During this time, the substrate is heated from 23° C. to 55° C. and the resulting layer is dried at 150° C. for 30 minutes. The added acid catalyzes the hydrolysis of the alkoxide, and heating in the course of gel formation leads to better crosslinking of the gel.

EP 0 597 490 describes a process for forming a silicon dioxide film on a glass substrate as an antireflection layer by applying to the glass substrate two organometallic silicon compounds of different molecular weight, from the group consisting of silicon alkylates and silicon acetylacetonates, which are dissolved in isopropyl alcohol or 1-butanol, and hydrolyzing the applied compounds at a relative atmospheric humidity of from 40 to 90%. By heating at a temperature of 100° C., the resulting sol film is converted to a gel film and then the coated substrate is heated to 550° C.

These processes have the disadvantage that owing to the use of solvents and organometallic compounds it is necessary to take special precautions in relation to environmental protection and explosion prevention, thereby complicating the processes and rendering them more expensive.

### SUMMARY OF THE INVENTION

An object of this invention is to provide a process for depositing metal oxide layers of optical quality on substrates which can be carried out without solvents and organometallic compounds.

Upon further study of the specification and appended claims, further objects and advantages of this invention will become apparent to those skilled in the art.

The objects are achieved in accordance with the invention by a process for depositing optical layers of metal oxides on glass, ceramics or metals, by

subjecting the substrate which is to be coated to a purifying pretreatment,

applying an aqueous sol or sol mixture to the substrate which is to be coated, and

heat-treating the coated substrate at temperatures of from 100 to 550° C.

The process achieves optically transparent, reflectively-altering layers of metal oxides on glass, ceramics or metals, having an infinitely adjustable refractive index of preferably from 1.22 to 2.20.

The starting material employed for coating the above-mentioned substrates comprises aqueous metal oxide sols which are obtained in accordance with the electrolytic process described, for example, in U.S. Pat. No. 5,378,400, from aqueous metal salt solutions at from 0° to 150° C. These sols contain, for example, from 0.3 to 15% of metal oxide. They are highly transparent and contain no stabilizers. By this process it is possible to prepare sols of aluminum oxide, titanium dioxide, zirconium oxide, hafnium oxide, niobium oxide or tantalum oxide or of oxides of actinides or lanthanides.

Despite the differing pH of the individual sols they can be mixed with one another and applied to the above-mentioned substrates in the manner described below. By mixing sols having different refractive indices it is possible to prepare optical layers having refractive indices of preferably from 1.45 to 2.2.

Also suitable as starting materials for the coating process are aqueous metal oxide sols, which are prepared by hydrolysis of organometallic compounds, especially alkoxides, by ion exchange from metal salt solutions, by microemulsion of alkoxides or metal salt solutions or by dialysis or electrodialysis in accordance with known methods. The particle size of these sols preferably lies in the range from 1 to 25 nm.

A microemulsion method is described by D. Burgard, R. Nass and H. Schmidt in Proceedings of the 2nd European Conference on Sol-Gel Technology, North Holland Publisher, Amsterdam 1992, pages 243-255. In J. Amer. Soc. 39 (1917) on page 71ff., M. Neidle and J. Barab describe the preparation of sols by dialysis. Electrodialysis methods are described by Prajapali, M. N. and Talpade, C. R. in Indian Chem. Manuf. 12(1), pages 13-21 (1974) and by Frolov, Yu. G. in D. I. Mendeleeva 107 (1979), pages 31ff.

The SiO₂ sols used as starting material, with particle sizes preferably of from 1 to 50 nm, can be prepared from the intermediate product of the process described in U.S. Pat. No. 4,775,520. They comprise SiO₂ particles obtained by hydrolytic polycondensation of tetraalkoxysilane in an aqueous-alcoholic-ammoniacal medium. The reaction mixture is subjected to steam distillation in order to remove the solvent and the ammonia, which is then suitable as starting material for the coating of the above-mentioned substrates.

It has surprisingly been found that a small addition of certain surfactants, for example of a mixture comprising 15-30% by weight anionic surfactants, 5-15% by weight nonionic surfactants and less than 5% by weight amphoteric surfactants, leads to porous layers whose refractive index is 1.30.

The sols are employed at concentrations preferably of from 0.1 to 20% by weight, more preferably from 2 to 10% by weight, based on the coating solution. The concentration depends on the type of coating process used. Immersion processes or spin-coating processes, for example, can be employed. No further additives are required apart from the preferred use of small amounts of detergents or customary commercial flow assistants, for example, from the company Byk-Gardner, and/or complexing agents, for example, ethylene-diaminetetraacetic acid or citric acid. The concentrations of detergents and flow assistants here is preferably less than 80% by weight, based on the solids content of the coating solution. Relative to the coating solution, the concentration of complexing agents is preferably less than 10% by weight.

Suitable substrate materials are glass, ceramics and metals, the latter, however, with the restriction that they must be wettable and must not provide any reaction with the protons present in the sol.

The substrate surface must be pretreated. This pretreatment entails cleaning with acetone, ethanol and water or alkaline cleaning, for example, using dilute sodium hydroxide solution, preference being given to 1 N NaOH. Also suitable are customary commercial cleaning baths known in the glass industry, for example, an RBS bath. The cleaning effect can be intensified by using ultrasound.

The preferred purifying pretreatment is an alkaline cleaning. Particularly preferred conditions therefor are:

sodium hydroxide solution (pH 11)

temperature: 95° C.

dishwashing machine for laboratory glass (chemically resistant glass)

additional scrubbing may be required in the case of great soiling

rinsing with water

neutralization with citric acid

These conditions are the common practice for chemically resistant glass.

It is possible to replace sodium hydroxide by an alkaline all-purpose cleaning agent. In this case, it is preferred that the cleaning agent contains a hydroxide because it serves two purposes: cleaning agent and agent for the pretreatment of the glass surface (formation of hydroxyl groups). Before the sols are incorporated into the coating solution they can be purified. A suitable process is pressure filtration, using filters having a pore size of from 0.2 to 2 μm.

Suitable processes for applying the coating solution to the substrate are, for example, immersion, spraying or rotational coating processes (spin coating).

In order to obtain technologically relevant coating speeds of about 10 cm/min it is preferred to reduce the concentration of sol in the coating solution. Dilution with 1 N HCl is preferred. In the case of immersion coating processes, the solids concentrations are therefore adjusted to from 2 to 5% by weight, based on the coating solution.

When employing the rotational coating process, solids concentrations preferably of from 2 to 20% by weight are used, based on the coating solution. To this end, the coating solution is distributed uniformly on the substrate and then the excess solution is removed by spinning, for example, at 2000 rpm.

The applied layers are heated to a temperature of from 100 to 550° C. over the course of, for example, 90 minutes and are left at the final temperature for about 5 minutes, for example. In the case of the deposition of titanium oxide layers, the applied layers may be predried at from 20 to 70° C. over a period of from 0.5 to 10 hours.

The heat-treated layers are of optical quality. The layer thickness can be adjusted in the case of single coating to from 10 to 300 nm, for example. The layer thickness is adjusted by varying the rate of spin coating or immersion and by altering the viscosity and solids content of the coating solution.

Coated glass plates can be cut without the layer splintering and exhibit abrasion resistance in accordance with the Taber Abraser Test (DIN 52347) analogous to those of the metal oxide layers prepared by hydrolysis of alkoxides. The layers obtained are stable in the salt spray test (DIN 50021 - CASS), stable on storage for 1000 hours at 85° C. and 85% relative humidity, and stable to UV irradiation (QUV-B test, DIN 53384-A). In comparison with uncoated soda-lime glass, a protective action relative to solarization effects was observed for the coated samples in the QUV-B test.

A great advantage of the process is that neither organometallic compounds nor solvents are necessary for preparation of the layers. Among other advantages, this means that the coating units required need not be equipped for explosion prevention, which is associated with a considerable cost saving.

The examples which follow are intended to illustrate the invention in more detail without restricting it.

In the foregoing and in the following examples, all temperatures are set forth uncorrected in degrees Celsius; and, unless otherwise indicated, all parts and percentages are by weight.

The entire disclosure of all applications, patents and publications, cited above and below, and of corresponding German Application No. 197 35 493.9, filed Aug. 16, 1997, and German Application No. 198 28 231.1, filed Jun. 25, 1998, are hereby incorporated by reference.

### EXAMPLE 1

Flat glass plates (soda-lime glass) are cleaned with a customary commercial cleaning bath (RBS bath), then with 1 N NaOH and then with demineralized water using ultrasound.

An aqueous ZrO₂ sol having a solids content of 8.6% by mass ZrO₂ and a viscosity of 2.25 mm²/s (manufacturer: Merck KGaA)is filtered through a 0.2 μm filter and is employed without further additives for the spin-off coating described below. The resulting coating solution is distributed uniformly on the substrate and the excess portion is removed by spinning at 2000 rpm. The glass plate covered with the coating solution is placed in a convection oven at room temperature and the oven is heated to 500° C. over the course of 90 minutes. After a holding time of 5 minutes at 500° C. the coated glass plate is cooled in the-oven. The resulting layer is completely transparent with a layer thickness of about 75 nm and visually has no defects whatsoever. The layer has a refractive index of 2.03 and is stable to weathering tests (85° C./85% relative humidity for 1000 hours), alternating temperature test (55° C./+125° C. in accordance with DIN 40046 sheet 4)L, CASS test(96 h) in accordance with DIN 50021 - CASS and QUV-B test (500 h, based on DIN 53384-A). The abrasion resistance (in accordance with DIN 52347) of the deposited layer is identical with the abrasion resistance of layers produced by hydrolysis of alkoxides.

### EXAMPLE 2

Using the sol described in Example 1, layers are prepared by immersion coating. To obtain technologically relevant coating speeds of about 10 cm/min the sol is diluted before being subjected to pressure filtration through a filter having a pore diameter of 0.2 μm. This is done by adding, to one part of sol, two parts of 1 N HCl and, to improve the flow properties, 4 drops of a customary commercial washing composition, for example Sunlicht Progress. The flat glass plates are pretreated as in Example 1.

Coating of the flat glass plates takes place by immersion at a removal speed of 90 mm/min. The coatings thus obtained are heat-treated as described above. The heat-treated layers are transparent and exhibit the same stability as the layers described in Example 1. Dot-shaped defects can be reduced by adding 1.6% by mass of acetylacetone.

### EXAMPLE 3

The flat glass plates are cleaned as described in Example 1. The sol employed is a neutral SiO₂ sol with a solids content of 10% by mass (manufacturer: Merck KGaA). The sol is diluted with 4 parts of demineralized water, subjected to pressure filtration through a filter having a pore diameter of 1 μm and adjusted to a pH 1.5 with concentrated hydrochloric acid. To improve the flow properties, 4 drops of a customary commercial washing composition are added to 100 ml of diluted sol. The coating solution thus obtained was applied as in Example 1 by spin-off application to the pretreated glass plates. All other conditions correspond to those of Example 1. Coatings of the same quality are obtained.

### EXAMPLE 4

The sols described in Examples 1 and 3 are mixed with one another in undiluted form prior to pressure filtration. The molar ratio of SiO₂:ZrO₂ are adjusted to 0.1; 1 and 10. In these proportions the sols are readily miscible and can be employed directly for spin coatings under the conditions already described in Example 1. All other conditions correspond to those of Example 1. In this way defect-free, transparent coatings having layer thicknesses in the region of 100 nm are obtained whose refractive index can be varied from 1.95 (SiO₂/ZrO₂ ratio=10) to 1.47 (SiO₂/ZrO₂ ratio=0.1)

### EXAMPLE 5

The pretreatment of the flat glass plates takes place as in Example 1. The sol employed is an acidic TiO₂ sol having a solids content of about 12% by mass. The sol is diluted with three parts of demineralized water. Application to the glass plates takes place by the spin-off process. The glass plates provided with the coating solution are spun at 1500 rpm for 60 s. They are then dried overnight at 70° C. and heat-treated under the conditions described in Example 1. Transparent coatings were obtained.

### EXAMPLE 6

The glass plates are cleaned as in Example 1. The sol employed is a neutral SiO₂ sol with a solids content of 10% by mass (manufacturer: Merck KGaA). The sol is diluted with 3 parts of demineralized water and then acidified with 2.8 g of concentrated HCl to 1000 g of dilute sol. For a coating solution for preparing porous layers, 0.7 g of a surfactant mixture is added dropwise to 1000 g of solution. The surfactant mixture consists of 20% sodium dodecylbenzenesulfonate, 10% sodium coconut fatty alcohol ether sulfate 3 EO and 5% dodecylpolyglycolether 7 EO, dissolved in water. Coating of flat glass plates takes place by immersion at a removal speed of 90 mm/min. The coatings thus obtained are heated to 550° C. and, following a holding time of 15 minutes in the oven, are cooled without regulation. The resulting layer has a refractive index of 1.30 and is stable with respect to the climatic tests set out in Example 1.

From the foregoing description, one skilled in the art can easily ascertain the essential characteristics of this invention and, without departing from the spirit and scope thereof, can make various changes and modifications of the invention to adapt it to various usages and conditions.

1. A process for depositing an optical layer of at least one metal oxide on a glass, ceramic or metal substrate, which comprises:
subjecting the substrate which is to be coated to a purifying pretreatment,
coating the substrate with an aqueous sol of the at least one metal oxide, and
heat-treating the coated substrate at a temperature of from 100 to 550° C.

2. The process of claim 1, wherein before heat treatment, the coated substrate is predried at from 20 to 70° C. over a period of from 0.5 to 10 hours.

3. The process of claim 1, wherein the aqueous sol contains a surfactant mixture which consists of 15-30% by weight of at least one anionic surfactant, 5-15% by weight of at least one nonionic surfactant and less than 5% of at least one amphoteric surfactant.

4. An article having a glass, ceramic or metal surface coated with an optically transparent, reflectively-altering layer of at least one metal oxide having an infinitely adjustable refractive index from 1.22 to 2.20.

5. An article having a glass, ceramic or metal surface coated with an optically transparent, reflectively-altering layer of at least one metal oxide having an infinitely adjustable refractive index from 1.22 to 2.20 prepared by the process of claim 1.

6. The process of claim 1, which is conducted without the use of an organic solvent.

7. The process of claim 1, wherein the aqueous sol contains 0.3 to 15% by weight of the at least one metal oxide.

8. The process of claim 1, wherein the metal oxide is aluminum oxide, titanium dioxide, zirconium oxide, hafnium oxide, niobium oxide, tantalum oxide, an actinide oxide, a lanthanide oxide or a mixture of any combination thereof.

9. The process of claim 1, wherein the aqueous sol has a particle size of from 1 to 25 nm.

10. The process of claim 1, wherein the aqueous sol is an SiO₂ sol with a particle size of from 1 to 50 nm.

11. The process of claim 1, wherein the heat-treating is conducted by heating to 100 to 550° C. over the course of 90 minutes and maintaining the final temperature for about 5 minutes.

12. The process of claim 1, wherein a coating layer of from 10 to 300 nm is provided thereby.
